(19) United States
(12) Patent Application Publication
(10) Pub. No.: US 2020/0250650 A1
(43) Pub. Date: Aug. 6, 2020

(54) Mobile Device Security for Electronic Payments

(71) Applicant: Google LLC, Mountain View, CA (US)

(72) Inventors: Aditya Gupta, Mumbai (IN); Manav Raman, Hyderabad (IN)

(21) Appl. No.: 16/641,822

(22) PCT Filed: Jun. 14, 2018
(86) PCT No.: PCT/US2018/037658

§ 371 Date: Feb. 25, 2020

Related U.S. Application Data
(60) Provisional application No. 62/550,291, filed on Aug. 25, 2017.

(51) Int. Cl. G06Q 20/32

(52) U.S. Cl. CPC G06Q 20/3263

(57) ABSTRACT

Process registrations of users in mobile payment services by receiving information to register a user for the mobile payment service. The information including a first data item of the user of a first type common to profiles used in at least one other electronic service offered by a provider also offering a mobile payment service, and at least one other data item of the user of another type. Identifying a user profile associated with at least one electronic service offered by the provider, other than the mobile payment service, that includes the first data item. Comparing the received information with the information in the identified user profile. Registering the user in the mobile payment service in response to the comparison indicating a match between at least one received other data item and a data item of the other type in the information in the identified profile.

### CROSS REFERENCE TO RELATED APPLICATIONS

This application claims the benefit of U.S. Provisional Application No. 62/550,291, filed Aug. 25, 2017 and entitled “Mitigating Subscriber Identity Module (SIM) Swap Fraud,” the disclosure of which is incorporated herein by reference in its entirety.

### TECHNICAL FIELD

The technology disclosed herein is related to managing registration for electronic payment. Particular embodiments relate to mitigating the risk posed by fraud modalities encountered particularly in payments using mobile devices.

### BACKGROUND

In mobile payments, instead of using methods like cash, check, and credit card, a customer can use a mobile phone to transfer money or to pay for goods and services. A customer can transfer money or pay for goods and services by, for example, sending a Short Message Service (SMS) message, using a Java application over General Packet Radio Service (GPRS), using a Wireless Application Protocol (WAP) service, over Interactive Voice Response (IVR), or other mobile communication technologies. A customer wishing to conduct mobile payments typically must register with a mobile payment service provider.

As of 2016, only thirteen percent of the U.S. adult population does not have a mobile phone, while almost twenty percent are considered to be “under banked,” that is, with access to a federally insured financial institution, but still electing to use services like check cashing, money transfers, payday loans, and pawnshops.

In most places outside the U.S., especially jurisdictions where a landline telecommunications infrastructure was not ubiquitous, more people have mobile phones than have bank accounts. For example, India has a vast non-banking population, many of whom reside in the rural areas and are cut off from access to basic financial services from a trusted source. However, as of 2012, India had nearly a billion mobile phone customers.

### SUMMARY

The technology described herein includes computer implemented methods, computer program products, and systems to process registrations of users in mobile payment services. In some examples of the technology, a mobile payment service receives information to register a user for the mobile payment service. The information includes a first data item of the user of a first type common to profiles used in at least one other electronic service offered by the provider. The information also includes at least one other data item of the user of another type. The mobile payment system identifies a user profile associated with at least one electronic service offered by the provider, other than the mobile payment service, that includes the first data item. The service compares the received information with the information in the identified user profile. The service then registers the user in the mobile payment service in response to the comparison indicating a match between at least one received other data item and a data item of the other type in the identified profile.

In some examples, the first data item is received from a mobile communications device of the user and/or comprises a unique identifier for a mobile communications device of the user. For example, first data item comprises one of the following unique identifiers for a mobile communications device of the user: a phone number of a mobile communications device of the user, and a subscriber identity module (SIM) identifier of mobile communications device of the user. In some such examples, the first data item is received from a mobile device of the user, e.g., the mobile communications device of the user, automatically upon requesting registration, and without separate entry by the user.

In some examples, the mobile payment system denies registration in the mobile payment service for the user in response to the comparison not indicating a match between at least one received other data item and a data item of the other type in the identified profile. In some such embodiments, in response to denying registration, the mobile payment system queries at least one third-party database using the first data item. Query results are received by the mobile payment system in response to querying the at least one third-party database using the first data item. The mobile payment system compares the received information with the received query results, and registers the user in the mobile payment service in response to the comparison indicating a match between at least one received other data item and a data item of the other type in the query results. In some such embodiments, the mobile payment system denies registration in the mobile payment service for the user in response to the second comparison not indicating a match between at least one received other data item and a data item of the other type in the query results.

In some examples, a match between at least one received other data item and a data item of the other type in the identified profile requires a match across each of a plurality of other data item types.

### BRIEF DESCRIPTION OF THE DRAWINGS

FIG. 1 is a block diagram depicting an operating environment to mitigate the risk of subscriber identity module (SIM) swap fraud in mobile payments, in accordance with certain example embodiments.

FIG. 2 is a block diagram illustrating methods to mitigate the risk of SIM swap fraud in mobile payments, in accordance with certain example embodiments.

FIG. 3 is a block diagram illustrating methods to mitigate the risk of SIM swap fraud in mobile payments, in accordance with certain example embodiments.

FIG. 4 is a block diagram illustrating methods to mitigate the risk of SIM swap fraud in mobile payments, in accordance with certain example embodiments.

FIG. 5 is a block diagram illustrating methods to mitigate the risk of SIM swap fraud in mobile payments, in accordance with certain example embodiments.

FIG. 6 is a block diagram depicting a computing machine and a module, in accordance with certain example embodiments.

### DETAILED DESCRIPTION OF THE EXAMPLE EMBODIMENTS

In a typical mobile payment model, a customer with a mobile phone and a bank account (including a bank account with a bank not having branches near the customer, which is typical in many rural locations) registers with a mobile payment provider. To execute a transaction, the payor requests a payment via his mobile phone using the mobile phone number of the payee, a mobile payment identifier of the payee (typically not private information) for receiving payments, the amount of money to be transferred, and a private mobile payment identifier of the payor linked to the payor's mobile phone. The initiated payment request is communicated from the payor's mobile phone to the mobile payment provider, for example, via SMS, WAP, or other communication channel. The mobile payment services of the payor and the payee then complete the transaction with the respective bank accounts of the payer and payee. Though the actual bank account numbers of the payer and payee typically are not involved in the customer-facing side of this transaction (hence increasing the security of the transaction should the payment request be compromised between the payor and the mobile payment service provider), mobile payment accounts are at risk of fraud and theft.

One modality of fraud in the typical mobile payment model described above is to obtain the private mobile payment identifier of a payee, along with other information sufficient to obtain a new subscriber identity module (SIM) card. While the mobile payment identifier alone is insufficient to request a fraudulent mobile payment, with information (such as the address of the payer) sufficient to obtain a new SIM card, fraudsters have reported the payer's phone missing to the police. With an official police report, the fraudsters were able to request a replacement SIM card from the mobile phone company. Installing the fraudulently obtained SIM card in a new phone allowed the fraudsters to use the stolen private mobile payment identifier to transfer funds out of the victim's bank account.

Several online providers that offer mobile payments also offer multiple other services. For example, a first well-known provider offers cloud computing services, video and music streaming, and shopping. A second well-known online service provider offers desktop applications, email, online storage, video conferencing, operating system updates, and shopping. A third well-known online service provider offers search, desktop applications, and online storage. Not all the services require registration.

By using and relying on the methods and systems described herein, the technology disclosed herein can mitigate the risk of fraud in linking financial accounts to phone numbers in cases where the financial account service is one of a plurality of services offered by a service provider. As such, the technology may be employed to detect fraud vectors, for example, use of a counterfeit SIM card.

Embodiments of the present technology include methods, systems, and computer program products to check if a phone number being registered with a service is already known to be associated with a different account across a service provider and not just on service in which the number is being registered. This includes checking for phone numbers registered on a device operating system that powers a vast majority of devices in India. This is a unique way of solving this problem because it prevents fraudsters from being able to sign up a stolen phone number even if the original phone number owner never signed up for service being registered with specifically, but may have signed up for any other service of the service provider. This implementation has increased utility where the service provider has a vast enough phone number pool across services.

### Example System Architectures

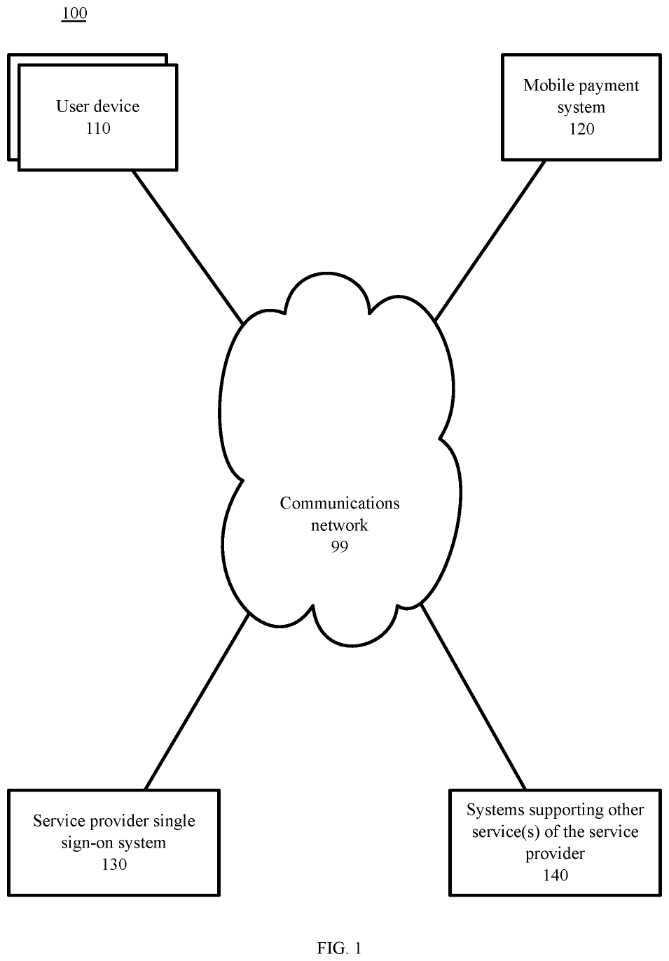

FIG. 1 is a block diagram depicting a communications and processing operating environment 100 in accordance with certain example embodiments. While each server, system, and device shown in the architecture is represented by one instance of the server, system, or device, multiple instances of each can be used. Further, while certain aspects of operation of the present technology are presented in examples related to FIG. 1 to facilitate enablement of the claimed invention, additional features of the present technology, also facilitating enablement of the claimed invention, are disclosed elsewhere herein.

As depicted in FIG. 1, the example operating environment 100 includes network devices 110, 120, 130, and 140; each of which may be configured to communicate with one another via communications network 99. In some embodiments, a user associated with a device must install an application and/or make a feature selection to obtain the benefits of the technology described herein.

Network 99 includes one or more wired or wireless telecommunications means by which network devices may exchange data. For example, the network 99 may include one or more of a local area network (LAN), a wide area network (WAN), an intranet, an Internet, a storage area network (SAN), a personal area network (PAN), a metropolitan area network (MAN), a wireless local area network (WLAN), a virtual private network (VPN), a cellular or other mobile communication network, a BLUETOOTH® wireless technology connection, a near field communication (NFC) connection, any combination thereof, and any other appropriate architecture or system, that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network device 110, 120, 130, and 140 can include a communication module capable of transmitting and receiving data over the network 99. For example, each network device can include a server, a desktop computer, a laptop computer, a tablet computer, a television with one or more processors embedded therein and/or coupled thereto, a smart phone, a handheld computer, a personal digital assistant (PDA), or any other wired or wireless processor-driven device.

The network connections illustrated are examples and other means of establishing a communications link between the computers and devices can be used. Moreover, those having ordinary skill in the art having the benefit of the present disclosure will appreciate that the network devices illustrated in FIG. 1 may have any of several other suitable computer system configurations. For example, computing device 110 may be embodied as a mobile phone or handheld computer and may not include all the components described above.

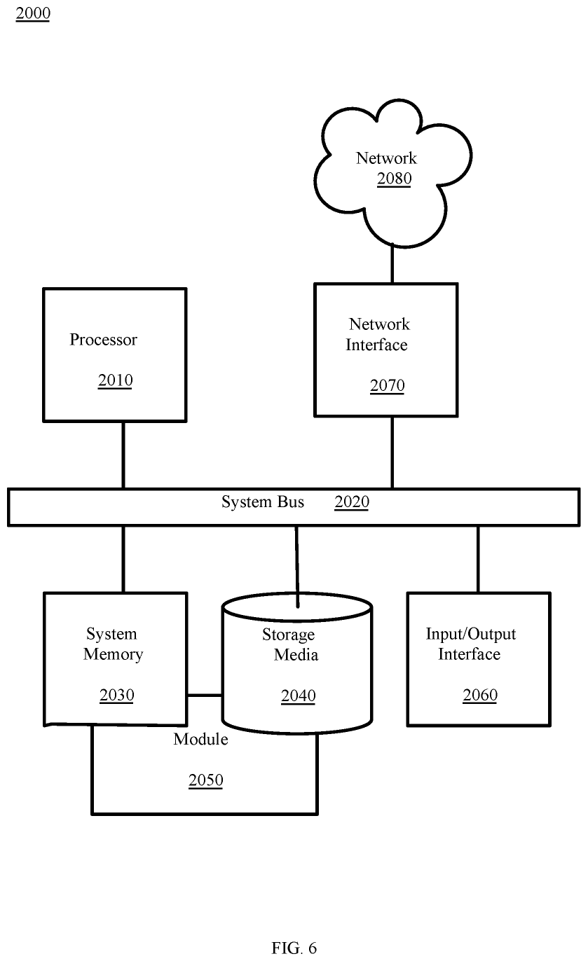

In example embodiments, the network computing devices, and any other computing machines associated with the technology presented herein, may be any type of computing machine such as, but not limited to, those discussed in more detail with respect to FIG. 6. Furthermore, any modules associated with any of these computing machines, such as modules described herein or any other modules (scripts, web content, software, firmware, or hardware) associated with the technology presented herein may be any of the modules discussed in more detail with respect to FIG. 6. The computing machines discussed herein may communicate with one another as well as other computer machines or communication systems over one or more networks, such as network 99. The network 99 may include any type of data or communications network, including any of the network technology discussed with respect to FIG. 6.

### Example Processes

The example methods illustrated in the figures are described hereinafter with respect to the components of the example operating environment 100. The example methods also can be performed with other systems and in other environments. The operations described with respect to any of the figures can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

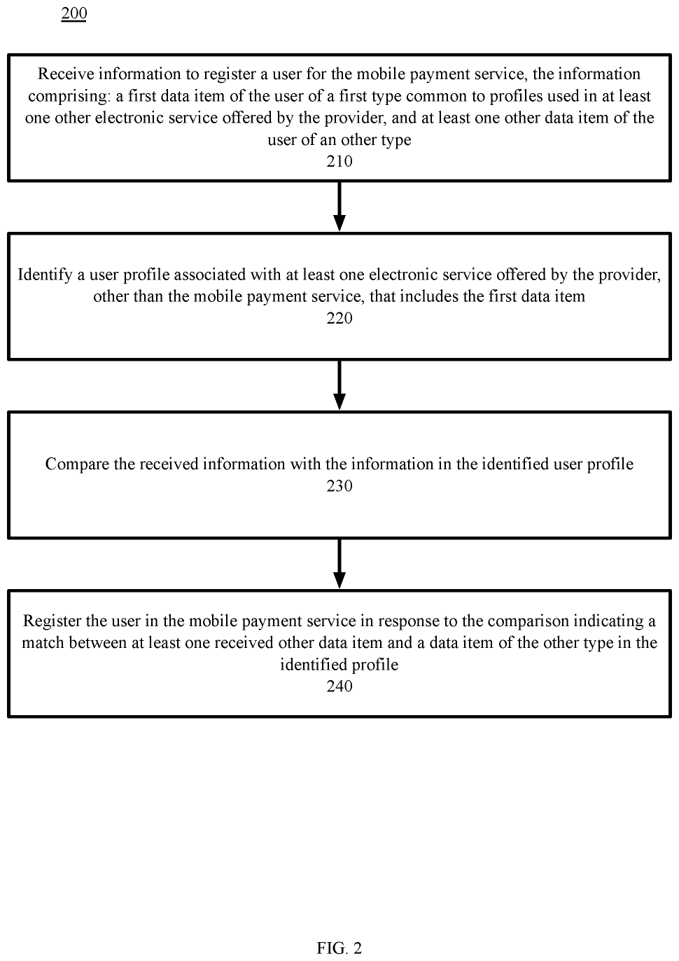

Referring to FIG. 2, and continuing to refer to FIG. 1 for context, methods 200 to process registrations of users in mobile payment services, in some cases to mitigate the risk of SIM swap fraud in mobile payments, are illustrated in accordance with certain examples. In such methods 200, a mobile payment system 120 supports one of a plurality of services (services supported by system 120 and system 140) of a service provider. The mobile payment system 120 receives information to register a user for the mobile payment service—Block 210. The information includes a first data item of the user of a first type common to profiles used in at least one other electronic service offered by the provider, and at least one other data item of the user of another type. In some examples, a single sign-on server 130 of the service provider receives the information and does the subsequent processing described herein.

In a continuing example, the user registers for the mobile payment service with the phone number “1234” and personal identifying information (PII) email address abc@service_provider.com. In a variation of the continuing example, the user has previously registered with a video conferencing service 140 offered by the service provider using the same e-mail. In some examples, an identifier of the SIM card of the user's mobile device is provided by the user's mobile device, and not through entry of the SIM card identifier by the user when the user begins registration for the mobile payment service.

The mobile payment system 120 identifies a user profile associated with at least one electronic service offered by the provider, other than the mobile payment service, that includes the first data item—Block 220. In the continuing example, the mobile payment system 120 scans other services 140 including video conferencing service of the service provider and finds that the same phone number “1234” was used in a profile to register for video conferencing services of the service provider.

The mobile payment system 120 compares the received information with the information in the identified user profile—Block 230. In the continuing example, the mobile payment system 120 compares the email address used to register for the mobile payment with the email address used to register with the video conferencing service, and determines that the same email address, abc@service-provider.com, was used to register for the video conferencing services over two years ago. The mobile payment system 120 registers the user in the mobile payment service in response to the comparison indicating a match between at least one received other data item and a data item of the other type in the identified profile—Block 240. In the continuing example, since the mobile payment server 120 determined that the same email address, abc@service-provider.com, was used to register for the video conferencing services, the mobile payment system 120 registers the user for mobile payments.

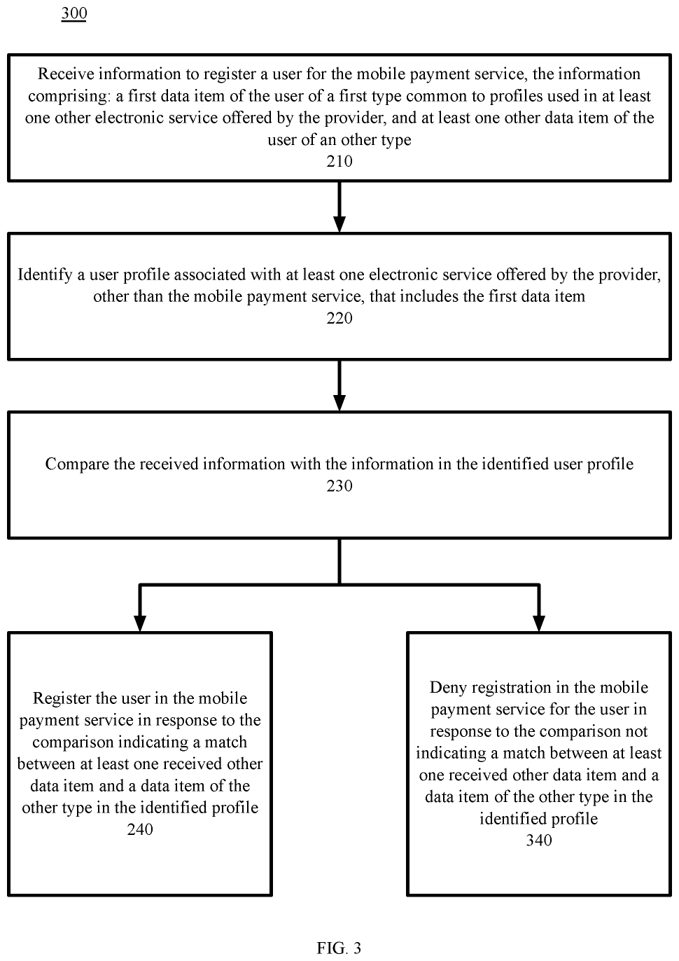

Referring to FIG. 3, and continuing to refer to prior figures for context, methods 300 to process registrations of users in mobile payment services, in some cases to mitigate the risk of SIM swap fraud in mobile payments, are illustrated in accordance with certain examples. In such methods, after comparing the received information with the information in the identified user profile (Block 230), the mobile payment system 120 denies registration in the mobile payment service for the user in response to the comparison not indicating a match between at least one received other data item and a data item of the other type in the identified profile—Block 340. In a variation of the continuing example, the mobile payment system 120 did not find common information between the received information and any previous registrations with the service provider, and therefore denied this method of registration for mobile payments.

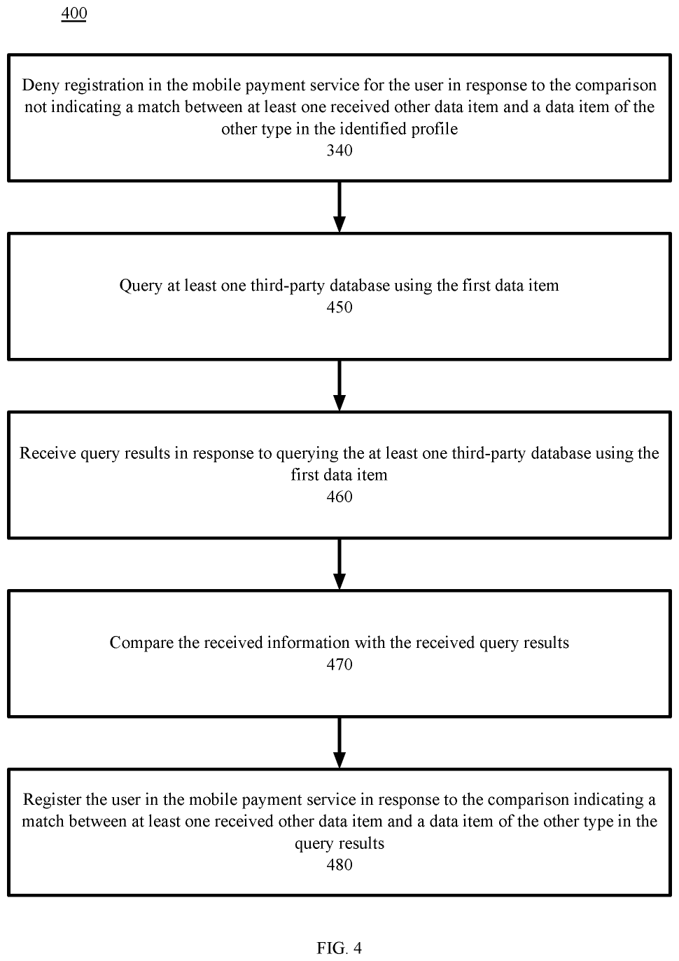

Referring to FIG. 4, and continuing to refer to prior figures for context, methods 400 to process registrations of users in mobile payment services, in some embodiments to mitigate the risk of SIM swap fraud in mobile payments, are illustrated in accordance with certain example embodiments. In such methods, after the mobile payment system 120 denies registration in response to the comparison not indicating a match (Block 340), the mobile payment system 120 queries at least one third-party database using the first data item—Block 450.

In the variation of the continuing example, the mobile payment system 120 compared the email address used to register for the mobile payments with the email address used to register with the video conferencing service, and determines that the different email address, xyz@service-provider.com, was used to register for the video conferencing services over two years ago. Now in response, the mobile payments system 120 the mobile payment service queries a third-party social network database using the user's phone number “1234.”

The mobile payment system 120 receives query results in response to querying the at least one third-party database using the first data item—Block 460. In the continuing example, querying the third party social network database returns the address “123 Main St.” and both abc@service-provider.com and xyz@service-provider.com as related e-mail addresses.

The mobile payment system 120 compares the received information with the received query results—Block 470. In the continuing example, the address “123 Main St.” is found to be associated with both abc@service-provider.com and xyz@service-provider.com. This correspondence can be determined from databases of the service provider or from third-party databases (such as public records). Rules and heuristics of the technology determine whether this correspondence is sufficient to present an acceptable risk of fraud for the user's registration for the mobile payment service. In the second variation of the continuing example, one out of two data fields corresponding is sufficient to present an acceptable risk of fraud.

The mobile payment service 120 registers the user in the mobile payment service 120 in response to the comparison indicating a match between at least one received other data item and a data item of the other type in the query results—Block 480. In the continuing example, because the comparison indicated a match, the mobile payment system registers the user's phone having number “1234” with the mobile payment service

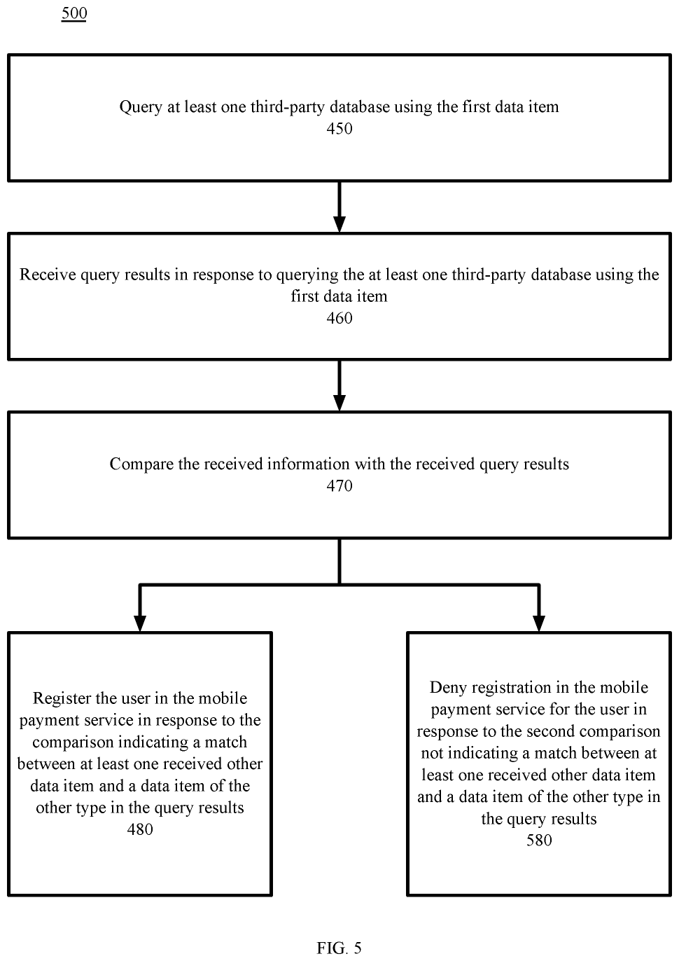

Referring to FIG. 5, and continuing to refer to prior figures for context, methods 500 to process registrations of users in mobile payment services, in some cases to mitigate the risk of SIM swap fraud in mobile payments, are illustrated in accordance with certain examples. In such methods, after comparing the received information with the information in the identified user profile (Block 470), the mobile payment system 120 denies registration in the mobile payment service for the user in response to the comparison not indicating a match between at least one received other data item and a data item of the other type in the identified profile—Block 580. In a variation of the continuing example, the mobile payment system 120 did not find common information between the received information and any previous registrations with the service provider, and therefore denied this method of registration for mobile payments.

### Other Example Embodiments

FIG. 6 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a router or other network node, a vehicular information system, one or more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to certain example embodiments, any of the processor 2010, the other elements of the computing machine 2000, or the various peripherals discussed herein may be integrated into a single device such as a system on chip (“SOC”), system on package (“SOP”), or ASIC device.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the scope of the following claims, which are to be accorded the broadest interpretation to encompass such alternate embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

1. A computer-implemented method to process registrations of users in a mobile payment service being one of a plurality of services supported by a service provider, comprising:
receiving, by one or more computing devices of the mobile payment service, information to register a user for the mobile payment service, the information comprising:
a first data item of the user of a first type common to profiles used in at least one other electronic service offered by the provider, and
at least one other data item of the user of another type;
identifying, by the one or more computing devices, a user profile associated with at least one electronic service offered by the provider, other than the mobile payment service, that includes the first data item;
comparing, by the one or more computing devices, the at least one received other data item with information in the identified user profile; and
registering, by the one or more computing devices, the user in the mobile payment service in response to the comparison indicating a match between the at least one received other data item and a data item of the other type in the information in the identified user profile.

2. The method of claim 1, wherein the first data item is received from a mobile communications device of the user and/or comprises a unique identifier for a mobile communications device of the user.

3. The method of claim 2, wherein the first data item is one of: a phone number of a mobile communications device of the user, and a subscriber identity module (SIM) identifier of a mobile communications device of the user.

4. The method of claim 3, wherein the first data item is received from the mobile communications device of the user automatically upon requesting registration, and without separate entry by the user.

5. The method of claim 1, further comprising:
denying, by the one or more computing devices, registration in the mobile payment service for the user in response to the comparison not indicating a match between the at least one received other data item and a data item of the other type in the information in the identified profile.

6. The method of claim 5, further comprising, in response to denying registration:
querying, by the one or more computing devices, at least one third-party database using the first data item;
receiving, by the one or more computing devices, query results in response to querying the at least one third-party database using the first data item;
comparing, by the one or more computing devices, the at least received other data item with the received query results; and
registering, by the one or more computing devices, the user in the mobile payment service in response to the comparison indicating a match between the at least one received other data item and a data item of the other type in the query results.

7. The method of claim 6, further comprising:
denying, by the one or more computing devices, registration in the mobile payment service for the user in response to the second comparison not indicating a match between at least one received other data item and a data item of the other type in the query results.

8. The method of claim 1, wherein a match between the at least one received other data item and a data item of the other type in the information in the identified profile comprises a match across each of a plurality of other data item types.

9. A computer program product, comprising:
a non-transitory computer-readable storage device having computer-executable program instructions embodied thereon that when executed by a computer cause the computer to process a registration of a user in a mobile payment service being one of a plurality of services supported by a service provider, the computer-executable program instructions comprising:
computer-executable program instructions to receive information to register a user for the mobile payment service, the information comprising: a first data item of the user of a first type common to profiles used in at least one other electronic service offered by the provider, and at least one other data item of the user of another type;
computer-executable program instructions to identify a user profile associated with at least one electronic service offered by the provider, other than the mobile payment service, that includes the first data item;
computer-executable program instructions to compare the at least one received other data item with information in the identified user profile; and
computer-executable program instructions to register the user in the mobile payment service in response to the comparison indicating a match between the at least one received other data item and a data item of the other type in the information in the identified user profile.

10. The computer program product of claim 9, wherein the first data item is received from a mobile communications device of the user and/or comprises a unique identifier for a mobile communications device of the user.

11. The computer program product of claim 10, wherein the first data item is one of: a phone number of a mobile communications device of the user, and a subscriber identity module (SIM) identifier of a mobile communications device of the user.

12. The computer program product of claim 11, wherein the first data item is received from the mobile communications device of the user automatically upon requesting registration, and without separate entry by the user.

13. The computer program product of any one of claim 9, wherein the computer-executable program instructions further comprise instructions to: deny registration in the mobile payment service for the user in response to the comparison not indicating a match between the at least one received other data item and a data item of the other type in the information in the identified profile.

14. The computer program product of claim 13, wherein the computer-executable program instructions further comprise instructions to: further comprising, in response to denying registration:
in response to denying registration, query at least one third-party database using the first data item;
receive query results in response to querying the at least one third-party database using the first data item;
compare the at least one received other data item with the received query results; and
register the user in the mobile payment service in response to the comparison indicating a match between the at least one received other data item and a data item of the other type in the query results.

15. The computer program product of claim 14, wherein the computer-executable program instructions further comprise instructions to:
deny registration in the mobile payment service for the user in response to the second comparison not indicating a match between at least one received other data item and a data item of the other type in the query results.

16. The computer program product of claim 9, wherein a match between at least one received other data item and a data item of the other type in the information in the identified profile comprises a match across each of a plurality of other data item types.

17. A system to process a registration of a user in a mobile payment service being one of a plurality of services supported by a service provider, comprising:
a storage device; and
a processor communicatively coupled to the storage device, wherein the processor executes application code instructions that are stored in the storage device to cause the system to:
receive information to register a user for the mobile payment service, the information comprising: a first data item of the user of a first type common to profiles used in at least one other electronic service offered by the provider, and at least one other data item of the user of another type;
identify a user profile associated with at least one electronic service offered by the provider, other than the mobile payment service, that includes the first data item;
compare the at least one received other data item with information in the identified user profile; and
register the user in the mobile payment service in response to the comparison indicating a match between at least one received other data item and a data item of the other type in the information in the identified user profile.

18. The system of claim 17, wherein the first data item is received from a mobile communications device of the user and/or comprises a unique identifier for a mobile communications device of the user.

19. The system of claim 18, wherein the first data item is one of: a phone number of a mobile communications device of the user, and a subscriber identity module (SIM) identifier of a mobile communications device of the user.

20. The system of claim 19, wherein the first data item is received from the mobile communications device of the user automatically upon requesting registration, and without separate entry by the user.

21. (canceled)
